(19) United States
(12) Patent Application Publication
(10) Pub. No.: US 2012/0085768 A1
(43) Pub. Date: Apr. 12, 2012

(54) Griddle, Use And Method For Manufacturing Griddles

(75) Inventor: Michel Serge Renzi, Chanaz (FR)

(73) Assignee: Karine RENZI, Chanaz (FR)

(21) Appl. No.: 13/376,980

(22) PCT Filed: Jun. 7, 2010
(86) PCT No.: PCT/EP2010/057941

§ 371 Date: Dec. 8, 2011

(30) Foreign Application Priority Data
Jun. 10, 2009 (FR) 0902788

(51) Int. Cl. A47J 37/10; B23K 1/002

(52) U.S. Cl. 220/573.1; 219/615

(57) ABSTRACT

A cooking pan and method of manufacture includes welding layers of aluminum, stainless steel and an intermediate anti-warping plate by induction brazing to provide a cooking pan having a substantially flat bottom and having substantially no voids between the layers to better distribute temperature across the flat bottom of the cooking pan and to form a thermal bottom which prevents the layers from deforming in response to heat applied thereto.

The invention relates to a cooking pan. The invention also relates to the use of a cooking pan and a method for manufacturing cooking pans.

Many forms of cooking pans, such as round frying pans, have been developed for cooking foodstuffs.

Conventionally, these cooking pans comprise one stamped steel sheet or else two stamped metal sheets fitted into one another, the bottom sheet being made of steel and the top sheet being made of aluminum or stainless steel.

It is found however that the stamping method limits the manufacture to cooking pans of round or oval shape for which the deformations of the outer edges of the stamped sheets are reduced. Specifically it is difficult to obtain right angles from the stamping method, the right angles being deformed into rounding or causing the bottom of the cooking pan to twist or curl.

In order to provide frying pan shapes having right angles, such as square or rectangular shapes, the cooking pans must comprise a sheet of stainless steel or of aluminum of great thickness, for example more than 2 cm. However, in this case, the pans become heavy and costly notably because of their large dimension.

Moreover, the pans sometimes include a non-stick coating on the top sheet in order to limit the build-up of grease and make cleaning easier, such as polytetrafluoroethylene. However, when the coating ages or is damaged, there may be ingestion of the coating which is a toxic product.

The object of the present invention is notably to solve the problems of the prior art by proposing an improved cooking pan that is both economical and strong and allows even cooking of the foodstuffs.

Accordingly, the subject of the invention is a cooking pan characterized in that it comprises a flat bottom comprising:
two layers of aluminum,
an intermediate anti-warping steel plate between said two layers of aluminum, and
two layers of stainless steel sandwiching said layers of aluminum and said intermediate anti-warping plate,
   said layers of aluminum, of stainless steel and said intermediate anti-warping plate being welded together by induction brazing and said flat bottom having a substantially square or rectangular general shape.

The succession of the various layers of aluminum, of stainless steel and the intermediate steel anti-warping plate brazed by induction, constitutes a “thermal bottom” giving a certain rigidity to the cooking pan, which will prevent the twisting or the bending of the stack of layers when it is heated, that is necessary to the square or rectangular shape of the cooking pan, while limiting its thickness. The succession of the various layers welded together by induction gives the cooking pan a greater rigidity thus allowing a rectangular shape without increasing the thickness. The square or rectangular shape of the cooking pan also allows a better geometric arrangement of the foodstuffs for cooking from one and the same heat source.

Moreover, the induction brazing of the various layers and of the intermediate anti-warping plate removes the air between the layers which makes it possible to improve the conduction of the cooking pan. The temperature is then better distributed in the bottom of the pan, which makes it possible to ensure even cooking of the foodstuffs and to limit the energy requirement necessary for cooking. When used on a conventional range, the smallest burner is sufficient to ensure any type of cooking.

Moreover, the top layer made of stainless steel prevents the foodstuffs from sticking to the surface of the cooking pan. This then limits the build-up of grease and makes cleaning easier without requiring a particular coating.

According to one or more other features of the cooking pan, taken in isolation or in combination,
the intermediate anti-warping plate comprises an electrical resistance,
the thickness of the intermediate anti-warping plate is between 1 and 2.5 millimeters,
the layers of stainless steel have a thickness of between 0.1 and 0.5 centimeters and the layers of aluminum have a thickness of between 1 and 3 millimeters,
the layers of stainless steel are brushed or polished,
said cooking pan comprises a ceramic coating,
said cooking pan comprises two removable handles having snap-fitting means.

A further subject of the invention is the use of a cooking pan as described above as a frying pan, stew pot, saucepan or skillet or as a hotplate.

A further subject of the invention is a method for manufacturing a cooking pan, characterized in that said layers of aluminum, of stainless steel and said intermediate anti-warping plate are welded together by induction brazing.

Other advantages and features will appear on reading the description of the invention and the appended figures in which:

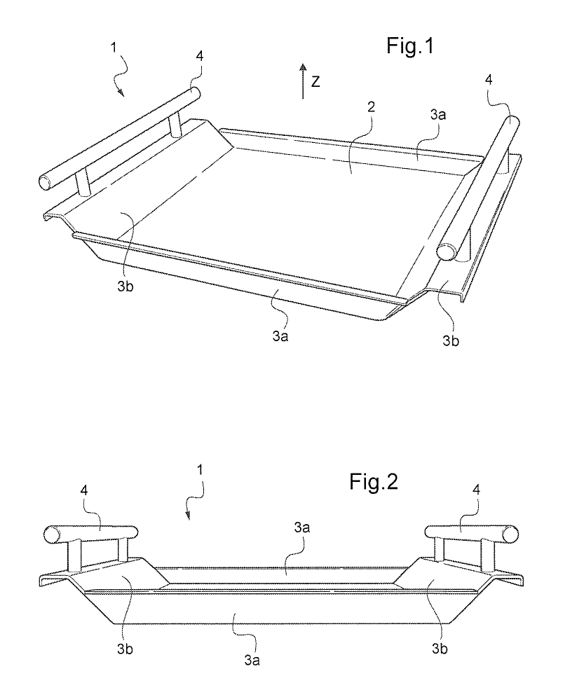

FIG. 1 is a view in perspective of a cooking pan,

FIG. 2 is a side view of the cooking pan of FIG. 1,

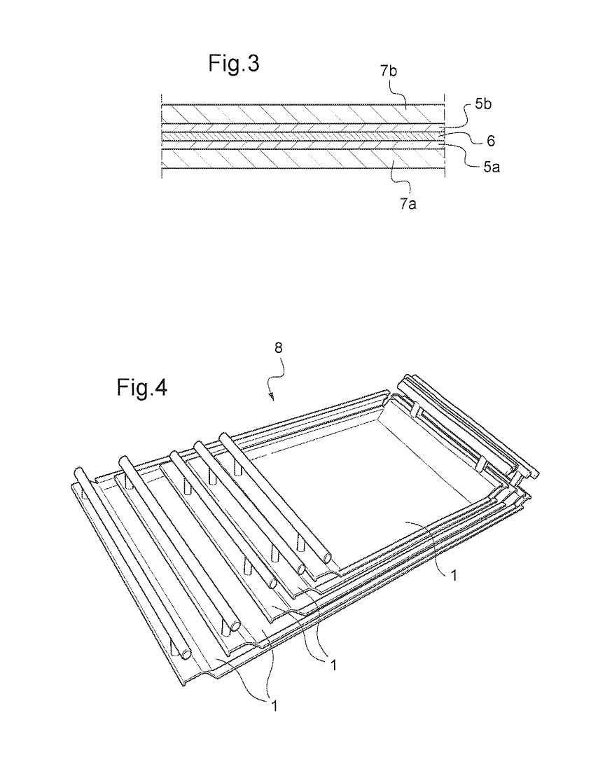

FIG. 3 is a partial schematized view in cross section of the cooking pan of FIG. 1, and

FIG. 4 is a view in perspective of a set of cooking pans.

In these figures, the identical elements bear the same reference numbers.

FIGS. 1 to 4 represent a cooking pan 1 designed to receive foodstuffs in order to cook them and capable of being used for example as a frying pan, such as a crepe pan or a wok, or as a stew pot, saucepan or skillet. It is possible to provide for this purpose a lid (not shown) for the cooking pan. It is also possible to use the cooking pan as a hotplate which has the advantage of being unbreakable.

The cooking pan 1 comprises a flat bottom 2 and flared outer edges. The flat bottom 2 has a substantially square or rectangular shape. The cooking pan 1 comprises four outer edges placed on the periphery of the flat bottom 2, forming a semiparallelepipidal cooking pan.

FIGS. 1 and 2 show a cooking pan 1 with a rectangular flat bottom having two edges 3a on the long sides forming an angle of approximately 90° with the flat bottom 2 and two inclined edges 3b on the short sides forming an angle of approximately 135° with the flat bottom 2. The outer edges 3b of the short sides and the outer edges of the long sides 3a are, for example, welded together along an assembly ridge forming an angle of 45° with the vertical straight line Z in FIG. 1. The assembly ridge may be made slightly curved so as not to have a sharp angle. It is possible to make provision also for the outer edges that are parallel two by two to be the same height. For example, the outer edges 3b of the short sides are designed to be higher than the outer edges 3a of the long sides. The height of the outer edges 3b of the short sides is for example of the order of 1 cm in the case of a frying pan and 13 cm in the case of a stew pot.

It is also possible for the outer edges to be formed at their ends to interact with an appropriate support (not shown). For example, as can be seen in the figures, the outer edges 3a, 3b are curved in the shape of a hook so that they can be set down and held by a corresponding support. The support is for example placed directly on a table and comprises one or more candles to be placed under the flat bottom 2, so as to keep the foodstuffs heated.

The cooking pan 1 may comprise a grip that can be removable or fixed at one outer edge of the pan, for example made of wood, of steel, of stainless steel or of synthetic resin (not shown).

It is also possible to have the cooking pan 1 comprise two handles 4, which may be removable or fixed, for example welded, screwed or riveted, placed respectively on the two opposite outer edges 3b of the flat bottom 2. The handles may be made of wood, of steel of stainless steel or of synthetic resin (see FIGS. 1 and 2). For example the cooking pan 1 comprises removable handles having snap-fitting means of the “retractable ball” type interacting with the outer edges 3b of the flat bottom 2. In the case of a rectangular cooking pan 1, the handles 4 are placed on the outer edges 3b of the short sides in order to make it easier to take hold of the cooking pan.

In the case of a grip or handle made of stainless steel, the cooking pan 1 is made to have at least one insulating spacer, for example made of synthetic resin such as the synthetic resin known by the name of the Bakelite brand, between the gripping portion and the outer edge of the pan.

More easily visible in FIG. 3 showing the cooking pan in section, the flat bottom 2 comprises two layers of aluminum 5a, 5b, an intermediate anti-warping steel plate 6 between said two layers of aluminum, and two layers of stainless steel 7a, 7b sandwiching said aluminum layers 5a, 5b and said intermediate anti-warping plate 6.

The layers of stainless steel 7a, 7b have for example a thickness of between 0.1 cm and 0.5 cm. Stainless steel T304, suitable in the food industry, is used for example.

The layers of aluminum 5a, 5b have for example a thickness of between 1 and 3 mm, for example 2 mm. The thickness of the intermediate antiwarping plate 6 is for example between 1 and 2.5 mm.

The layers of stainless steel 7a, 7b may be brushed or polished. Provision is made for example for the inside of the cooking pan 1 which is designed to accommodate the foodstuffs to be polished while the outside is brushed.

The stack of the various layers of aluminum 5a, 5b, the layers of stainless steel 7a, 7b and the anti-warping intermediate plate 6 is conductive of electricity so that it is possible to use a manufacturing method by induction brazing in order to connect them together.

Induction brazing consists in running an electrical current in a solenoid called an “inductor” which will create a variable magnetic field. The electrically conductive stack of the aluminum layers 5a, 5b, of stainless steel 7a, 7b and the intermediate anti-warping plate 6 are placed in the field or close to the latter. The stack is then the seat of inductive electromotive forces (induced currents) which dissipate the heat in the stack of layers.

For this, for example an item of equipment is used comprising a high-frequency generator (from 0.1 to several MHz) and comprising one or more presses, for example hydraulically-controlled presses. Each press supports a high-frequency inductor for the brazing of the parts to be treated. The inductor heats a support that converts electromagnetic energy into heat (a “susceptor”) which transmits by conduction the heat to the stack of layers. A powder (solder) is melted between the plates that are pressed.

The succession of the various layers of aluminum 5a, 5b, of stainless steel 7a, 7b and the intermediate anti-warping steel plate 6 brazed by induction forms a “thermal bottom” giving a certain rigidity to the cooking pan 1, which will prevent the stack of layers from twisting or curving when it is heated, which is necessary to the square or rectangular shape of the cooking pan, while limiting its thickness. The succession of the various layers welded together by induction gives the cooking pan 1 greater rigidity thus allowing a rectangular shape without increasing the thickness. The square or rectangular shape of the cooking pan 1 also allows a better geometric arrangement of the foodstuffs for cooking based on one and the same source of heat.

Moreover, the induction brazing of the various layers 5a, 5b, 7a, 7b and of the intermediate anti-warping plate 6 removes the air between the layers which makes it possible to improve the conduction of the cooking pan 1. The temperature is then better distributed in the bottom 2 of the pan 1, which makes it possible to ensure even cooking of the foodstuffs and limits the energy requirement necessary for cooking. When used on a conventional range, the smallest burner is sufficient to ensure any type of cooking.

Moreover, the top layer made of stainless steel 7b prevents the foodstuffs from sticking to the surface of the cooking pan. This then limits the build-up of grease and makes cleaning easier without requiring a particular coating.

Therefore, when they are used, the cooking pans 1 are heated by means of the flame of a gas burner, electrical resistances or induction hotplates.

According to one exemplary embodiment, the intermediate anti-warping plate 6 comprises an electrical resistance in order to supply a power for example of the order of 200 W. The electrical resistance may be adapted to be powered with a voltage of 220 V. Provision is made, for example, to bury the intermediate anti-warping plate 6 in the two layers of aluminum 5a, 5b.

When they are used, the cooking pans 1 comprising an intermediate anti-warping plate 6 having an electrical resistance make it possible to cook, keep the foodstuffs hot or reheat them.

As can be distinguished in FIG. 4, it is possible to provide a cooking pan set 8 comprising a plurality of nested cooking pans 1 formed to be stacked inside one another. This makes them easier to store.

Shown in this example is a cooking pan set 8 comprising five cooking pans 1 stacked inside one another. Note that the substantially square shape makes storage easier. The dimensions are for example in centimeters: 24×30, 28×45, 26.3×38, 24.3×31 and 20.3×22.

It can therefore be understood that the cooking pan 1 has an internal structure making it possible to have a square or rectangular shape while being both economic and strong and allowing even cooking of the foodstuffs.

1. A cooking pan having a flat, substantially square or rectangular shaped bottom, the cooking pan comprising:
two layers of aluminum;
an intermediate anti-warping steel plate disposed between said two layers of aluminum; and
two layers of stainless steel sandwiching said layers of aluminum and said intermediate anti-warping plate wherein said layers of aluminum of stainless steel and said intermediate anti-warping plate are welded together by induction brazing and in that said flat bottom has a substantially square or rectangular general shape.

2. The cooking pan as claimed in claim 1 wherein the intermediate anti-warping plate comprises an electrical resistance.

3. The cooking pan as claimed in claim 1 wherein the thickness of the intermediate anti-warping plate is between 1 and 2.5 millimeters.

4. The cooking pan as claimed in claim 1 wherein the layers of stainless steel have a thickness of between 0.1 and 0.5 centimeters and the layers of aluminum have a thickness of between 1 and 3 millimeters.

5. The cooking pan as claimed in claim 1 wherein the layers of stainless steel are brushed or polished.

6. The cooking pan as recited in claim 1 further comprising removable handles having snap-fitting means.

7. The use of a cooking pan as recited in claim 1 as one or more of: a frying pan, stew pot, saucepan or skillet.

8. The use of a cooking pan as recited in claim 1 as a hotplate.

9. A method for manufacturing a cooking pan the method comprising welding layers of aluminum, stainless steel and an intermediate anti-warping plate by induction brazing to provide a cooking pan having a substantially flat bottom and so as to substantially remove any voids between the layers to better distribute temperature across the flat bottom of the cooking pan and to form a thermal bottom which prevents the layers from deforming in response to heat applied thereto.

10. A cooking pan comprising:
an anti-warping steel plate having first and second opposing surfaces;
a first layer of aluminum disposed over a first one of the first and second opposing surfaces of said anti-warping steel plate;
a second layer of aluminum disposed over a second one of the first and second opposing surfaces of said anti-warping steel plate;
a first layer of stainless steel disposed over a first one of the first and second layers of aluminum; and
a second layer of stainless steel disposed over a second one of the first and second layers of aluminum.

11. The cooking pan of claim 10 wherein said layers of aluminum, of stainless steel and said intermediate anti-warping plate are welded together by induction brazing.

12. The cooking pan of claim 12 wherein the cooking pan has a substantially flat bottom and a substantially square or substantially rectangular shape.

13. The cooking pan of claim 10 wherein said anti-warping plate has a thickness in the range of about 1 millimeter (mm) to about 2.5 mm.

14. The cooking pan of claim 10 wherein:
the cooking pan has a substantially flat bottom and a substantially rectangular shape;
said anti-warping plate has a thickness in the range of about between 1 millimeter (mm) and 2.5 mm.
each of the layers of stainless steel are provided having a thickness in the range of about 0.1 centimeter (cm) to about 0.5 cm; and
each of the layers of aluminum have a thickness in the range of about 1 millimeter (mm) to about 3 mm.

15. The cooking pan of claim 14 further comprising:
a first edge member coupled to a first side of the cooking pan and forming an angle of approximately 90° with the flat bottom;
a second edge member coupled to a second side of the cooking pan opposite the first side and forming an angle of approximately 90° with the flat bottom;
a first inclined edge member coupled to a third side of the cooking pan and forming an angle of approximately 135° with the flat bottom; and
a second inclined edge member coupled to a fourth side of the cooking pan opposite the third side and forming an angle of approximately 135° with the flat bottom.

16. The cooking pan of claim 15 wherein each of the first, second, third and fourth edge members are welded to the respective sides of the cooking pan and to each other.

17. The cooking pan of claim 16 wherein each of the first, second, third and fourth edge members are welded to the respective sides of the cooking pan along an assembly ridge forming an angle of 45°.

18. The cooking pan of claim 10 wherein:
said anti-warping plate has a thickness between 1 millimeter (mm) and 2.5 mm.
each of the layers of stainless steel has a thickness between 0.1 centimeter (cm) and 0.5 cm; and
each of the layers of aluminum has a thickness between 1 mm and 3 mm.

19. The cooking pan of claim 18 wherein the cooking pan has a substantially flat bottom and a substantially rectangular shape;

20. The cooking pan of claim 18 wherein said anti-warping plate, said layers of stainless steel and said layers of aluminum are joined by induction brazing so as to substantially remove any voids between the layers to better distribute temperature across the bottom of the pan and to form a thermal bottom which prevents the stack of layers from deforming in response to heat applied thereto.
